(19) United States
(12) Patent Application Publication
(10) Pub. No.: US 2005/0185071 A1
(43) Pub. Date: Aug. 25, 2005

(54) Image signal processing apparatus

(75) Inventors: Tatsuya Takahashi, Ogaki-shi (JP); Tomomichi Nakai, Hashima-gun (JP); Toshio Nakakuki, Mizuho-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/038,529

(22) Filed: Jan. 21, 2005

(30) Foreign Application Priority Data
Jan. 23, 2004 (JP) 2004-015045

(51) Int. Cl. H04N 5/202; H04N 5/217

(52) U.S. Cl. 348/254; 348/241

(57) ABSTRACT

An image signal processing apparatus solves a problem of an increase in noise component contained in an image signal due to the gamma correction when a signal level is in a region where a slope of conversion characteristic is sharp, which problem has been detected in an image signal processing apparatus including gamma correction processing performed for achieving nonlinear conversion. The image signal is input to each of LPFs 40 and 42 which differ in transmission characteristic, and a selector 44 selects either one of outputs from the LPFs to send the selected output to the gamma correction circuit. The switching by the selector 44 is controlled by the filter control circuit 32. In the filter control circuit 32, a comparator 60 compares a signal level of an object pixel with a threshold value R. In the case where the signal level of the object pixel is in the region where the slope of conversion characteristic is sharp (less than R), the selector 44 is so controlled as to select the output from the LPF 42 which has a lower cutoff frequency and a larger noise component elimination effect as compared with the LPF 40.

### CROSS-REFERENCE TO RELATED APPLICATIONS

The priority application Number JP2004-015045 upon which this patent application is based is hereby incorporated by reference.

### FIELD OF THE INVENTION

The present invention relates to an image signal processing apparatus for performing a gradation correction of an image signal, particularly, to a suppression of noise caused in the gradation correction processing based on a nonlinear characteristic.

### BACKGROUND OF THE INVENTION

Gradation is one of image qualities in an image pickup apparatus such as a digital camera, and, generally, the image pickup apparatus is provided with a gradation correction circuit for correcting the gradation. The gradation correction circuit converts a level of an image signal input thereto and outputs the converted image signal according to the prescribed conversion characteristic function. For example, a gamma correction circuit is one of the circuits for the gradation correction. FIG. 1 is a schematic graph showing a conversion characteristic. The conversion characteristic is generally nonlinear. The gradation is expanded when a slope is larger than 1 (i.e. a change in output image signal is relatively larger than a change in input image signal), while the gradation is compressed when the slope is smaller than 1 (i.e. the change in output image signal is relatively smaller than the change in input image signal). As shown in FIG. 1, settings in ordinary gradation adjustment is such that a slope of the conversion characteristic for a range of relatively low input image signal levels is relatively large in order to ensure a contrast (gradation) while a slope of the conversion characteristic for a range of relatively high input image signal levels is relatively small in order to suppress the contrast.

FIG. 2 is a block diagram showing a constitution of a conventional image signal processing apparatus. An image signal output from an image pickup device 2 such as a CCD (Charge Coupled Device) image sensor is processed in an analog signal processing circuit 4 and then converted into digital data in an A/D conversion circuit 6 to be input to a digital signal processing circuit 8. The digital signal processing circuit 8 has an LPF (Low Pass Filter) 10 as a filter for eliminating noise which causes moire. The LPF 10 traps a frequency component of which frequency is ½ of a sampling frequency with respect to each of a vertical direction and a horizontal direction. Further, the digital signal processing circuit 8 performs signal processing such as a color separation, a gamma correction, and an outline correction. For instance, a gamma correction circuit 12 converts a signal level of the image signal input from the LPF 10 based on the nonlinear conversion characteristic shown in FIG. 1.

The conventional gradation correction processing has a problem of enlarging a noise component (random noise, horizontal trailing noise) contained in an image signal when an image signal level has the sharp slope of the conversion characteristic shown in FIG. 1. Particularly, since a ratio of the noise component to the image signal is relatively large in the case of a low input image signal level, image quality degradation due to the amplified noise component becomes prominent when the slope of the conversion characteristic is large at the low input image signal level as shown in FIG. 1.

### SUMMARY OF THE INVENTION

The present invention has been accomplished in the aim of solving the above problem, and an object thereof is to suppress image quality degradation caused by a noise component in an image signal processing apparatus which performs gradation correction processing based on a nonlinear conversion characteristic.

The image signal processing apparatus according to this invention comprises: a filter circuit which is disposed serially with a gradation correction circuit and attenuates a noise component contained in an image signal, a noise component attenuation characteristic of the filter circuit being variable; and a filter control circuit which judges a signal level of the image signal corresponding to a pixel and changes the noise component attenuation characteristic of the filter circuit for the pixel in accordance with the signal level.

### BRIEF DESCRIPTION OF THE DRAWINGS

FIG. 1 is a schematic graph showing a conversion characteristic of a gamma correction circuit.

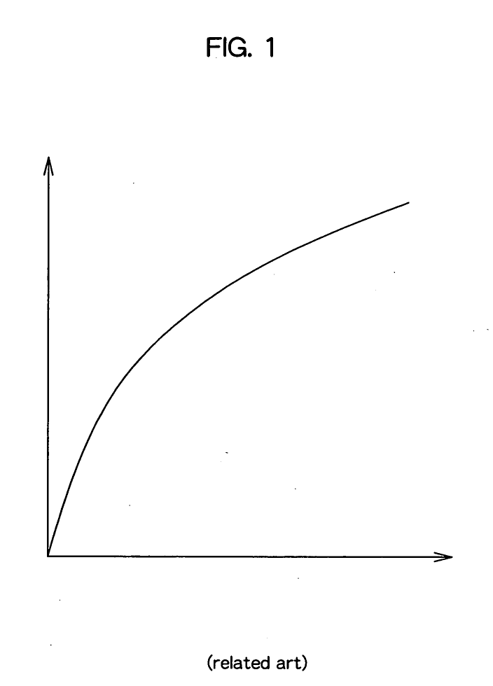

FIG. 2 is a block diagram showing a constitution of a conventional image signal processing apparatus.

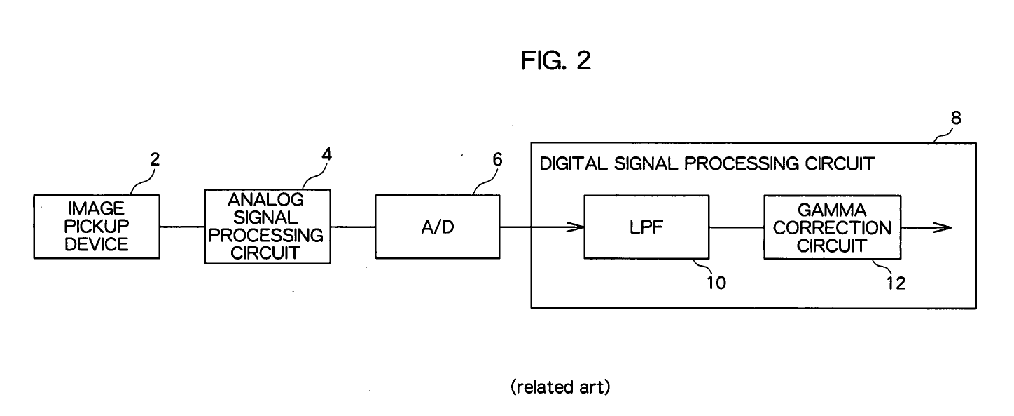

FIG. 3 is a schematic block diagram showing a constitution of an image signal processing apparatus according to one embodiment of the present invention.

FIG. 4 is a schematic graph showing one example of the conversion characteristic of the gamma correction circuit, which is used for describing this invention.

FIG. 5 is a block diagram schematically showing examples of circuit configurations of a filter circuit and a filter control circuit.

FIG. 6 is a graph showing a frequency characteristic indicating a transmission characteristic of an LPF.

FIG. 7 is a block diagram schematically showing circuit configurations of the filter circuit and the filter control circuit, the circuit configurations being different from those shown in FIG. 5.

### DESCRIPTION OF THE PREFERRED EMBODIMENTS

To start with, a brief description of a basic constitution of an image signal processing apparatus according to one preferred embodiment of this invention will be given below.

The basic constitution is such that the image signal processing apparatus according to the embodiment of this invention has a filter circuit and a filter control circuit. The filter circuit is disposed serially with a gradation correction circuit and attenuates a noise component contained in an image signal, and a noise component attenuation characteristic of the filter circuit is variable. The filter control circuit judges a signal level of the image signal corresponding to a pixel and changes the noise component attenuation characteristic of the filter circuit for the pixel in accordance with the signal level.

For instance, a plurality of signal level ranges are set based on expansions of gradations by the gradation correction circuit, and the filter control circuit sets an attenuation characteristic having a high noise component attenuation degree when a degree of the expansion of the signal level range to which the detected signal level belongs is high.

In one example of the image signal processing apparatus, the filter circuit is a low pass filter including a digital filter, and the filter control circuit changes tap coefficients of the digital filter to change a cutoff frequency of the low pass filter.

In another example of the image signal processing apparatus, the filter circuit has a median filter processing function, and the filter control circuit switches between performance and non-performance of the median filter processing function or between median filter sizes.

In response to a change in slope of a conversion characteristic of gradation correction processing in accordance with the signal level, the image signal processing apparatus changes the attenuation characteristic of the filter circuit which attenuates the noise component in accordance with the signal level. More specifically, a filter detection circuit detects a signal level of an image signal changing in a screen, and, in the case where the signal level is the one whose noise component is enlarged by the conversion characteristic, the filter control circuit changes the attenuation characteristic of the filter circuit to that enhances an ability of attenuating the noise component. With such constitution, in the case where a noise component of a signal level is acceptable, a suitable resolution is maintained by setting an attenuation characteristic having a relatively low noise component attenuation ability. On the other hand, in the case of a signal level at which a noise component is enlarged, image quality degradation is sufficiently suppressed by setting an attenuation characteristic having a relatively high noise component attenuation ability.

Foregoing is the brief description of the basic constitution of the image signal processing apparatus according to the preferred embodiment of this invention. Hereinafter, specific constitutions of the embodiment will be described with reference to the drawings.

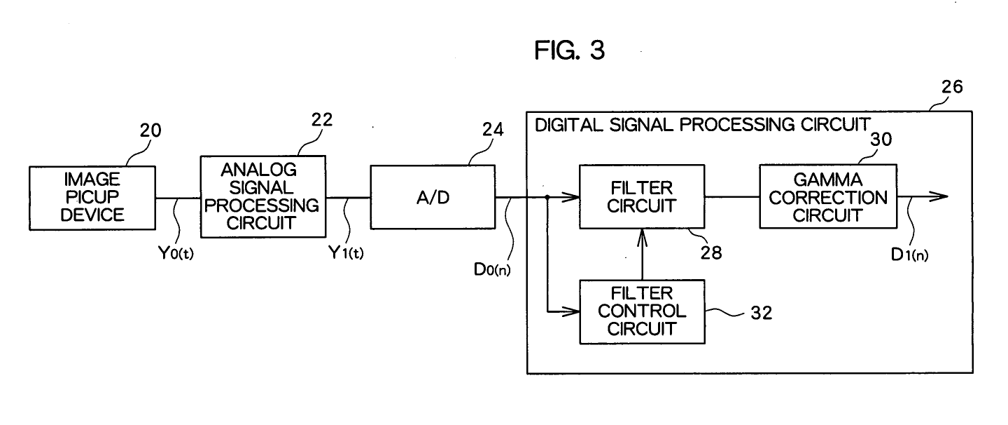

FIG. 3 is a schematic block diagram showing a constitution of an image signal processing according to the embodiment of this invention. The image signal processing apparatus generates gradation-corrected image data based on an image signal output from an image pickup device 20. The image pickup device 20 is a CCD image sensor, and an image signal Y0(t) output from the image pickup device 20 is input to an analog signal processing circuit 22. The analog signal processing circuit 22 performs processing such as sample hold and AGC (Auto Gain Control) on the image signal Y0(t) to generate an image signal Y1(t) which is in conformity with a predetermined format. An A/D conversion circuit 24 converts the image signal Y1(t) output from the analog signal processing circuit 22 into digital data to output image data D0(n). A digital signal processing circuit 26 fetches the image data D0(n) from the A/D conversion circuit 24 to perform various processing. Here, the digital signal processing circuit 26 is provided with a filter circuit 28, which is a low pass filter, for eliminating a noise component such as a moire noise, a random noise, and a crosscut noise. A transmission characteristic of the filter circuit 28 is changed so as to change a noise component attenuation characteristic. A filter control circuit 32 controls the change in transmission characteristic of the filter circuit 28 based on a signal level of an image signal. A gamma correction circuit 30 performs processing for converting the signal level based on a nonlinear conversion characteristic of the image signal sent from the filter circuit 28 to output the image signal as image data D1(n). In addition, the digital signal processing circuit 26 is capable of performing other signal processing such as color separation and outline correction, but descriptions thereof are omitted herein.

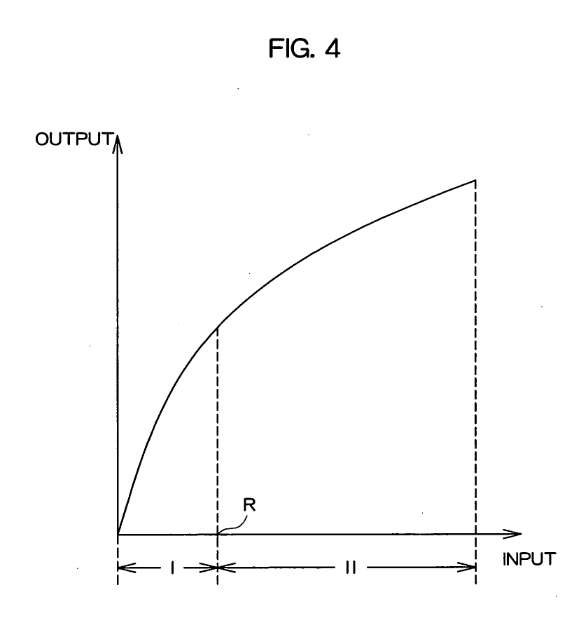

FIG. 4 is a schematic graph showing one example of the conversion characteristic of the gamma correction circuit 30. A horizontal axis of FIG. 4 indicates the signal level of the input image signal, and the vertical axis of the FIG. 4 indicates the signal level of the output image signal.

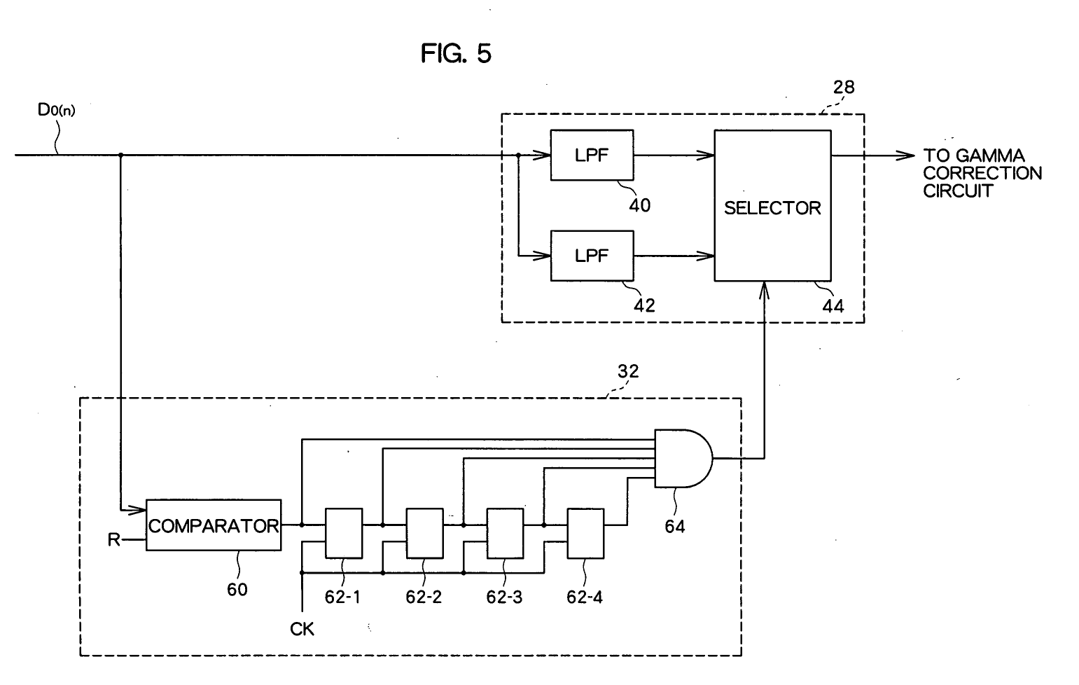

FIG. 5 is a block diagram showing schematic circuit configurations of the filter circuit 28 and the filter control circuit 32. The filter circuit 28 includes LPFs 40 and 42 having transmission characteristics different from each other and a selector 44 for selecting either one of outputs from the LPFs 40 and 42. Each of the LPFs 40 and 42 includes an LPF (VLPF) for a vertical direction and an LPF (HLPF) for a horizontal direction.

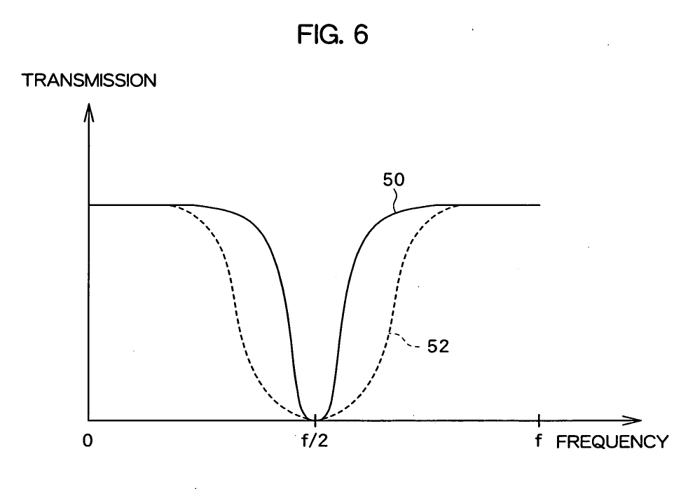

The VLPF of each of the LPFs 40 and 42 traps a frequency component including a frequency that is ½ of a vertical sampling frequency fv and nearby frequencies. FIG. 6 is a frequency characteristic graph showing examples of the transmission characteristics of the LPFs 40 and 42, and a sampling frequency f in FIG. 6 means a vertical sampling frequency fv or a horizontal sampling frequency fh. Each of the LPFs 40 and 42 has a minimum point at ½ of the sampling frequency f and attenuates the output signal near the minimum point, but bandwidths to be attenuated are different from each other. Since a cutoff frequency of a characteristic 50 of the LPF 40 is set to a high value so as to prevent an image resolution from being degraded due to the filtering, the characteristic 50 includes a sharp attenuation characteristic of f/2. In turn, since a cut off frequency of a characteristic 52 of the LPF 42 is set to a low value as compared with that of the characteristic 50, the characteristic 52 includes a gently sloping attenuation characteristic. Therefore, the LPF 42 causes the attenuation in a wider range of bandwidths and has a higher degree of attenuating a noise component as compared with the LPF 40. The LPFs 40 and 42 can be realized by using a digital filter, and, in such case, the characteristics 50 and 52 are realized by varying tap co efficiencies of the LPFs 40 and 42.

The filter control circuit 32 includes a comparator 60, a plurality of serially connected DFFs (Delay Flip Flops) 62, and an AND circuit 64. The image signal is input to the comparator 60, and the comparator 60 compares the image data D0(n) with threshold value data R and, for instance, outputs a logical value “H” when D0(n)≧R or a logical value “L” when D0(n)<R. The threshold value R is defined as a signal level which divides the input signal levels into a range I including the low signal levels having the relatively sharp slope and a range II including the high signal levels having the relatively gentle slope. The output data of the comparator 60 are input to the DFF 62-1 and then transferred to the serially connected DFFs 62-1, 62-2, 62-3, and 62-4 sequentially in synchronization with a clock of a horizontal sampling. Outputs from the comparator 60 and the DFFs 62-1 to 62-4 are input to the AND circuit 64. The AND circuit 64 outputs the logical value “H” when signal levels of five adjacent pixels in the horizontal direction are equal to or higher than the threshold value R and outputs the logical value “L” when any one of the signal levels of the five pixels is lower than the threshold value R.

In the case where the output from the AND circuit 64 is H, the selector 44 selects the LPF 40 which is capable of maintaining the resolution thanks to the relatively low noise component attenuation degree as the LPF for performing filtering on the central pixel of the five pixels based on which the output has been executed and sends the output to the gamma correction circuit 30. In the case where the output from the AND circuit 64 is L, the selector 44 selects the LPF 42 which has the relatively high noise component attenuation degree as the LPF for performing filtering on the central pixel of the five pixels based on which the output has been executed and sends the output to the gamma correction circuit 30.

In this apparatus, the selector 44 performs the switching based on the result of the comparison of the signal levels of adjacent pixels with the threshold value R performed by the DFFs 62 and the AND circuit 64. With such constitution, an image quality is prevented from being degraded due to frequent switching between the LPFs 40 and 42 in a pixel region having signal levels close to R. An OR circuit can be used in place of the AND circuit 64 for the purpose of the prevention of image quality degradation. Also, the number of the pixels used in the AND processing (OR processing) can be changed. Further, the circuit may be simplified by performing the switching of the selector 44 based on a result of comparison of image data of one pixel at a filtering object position with the threshold value R.

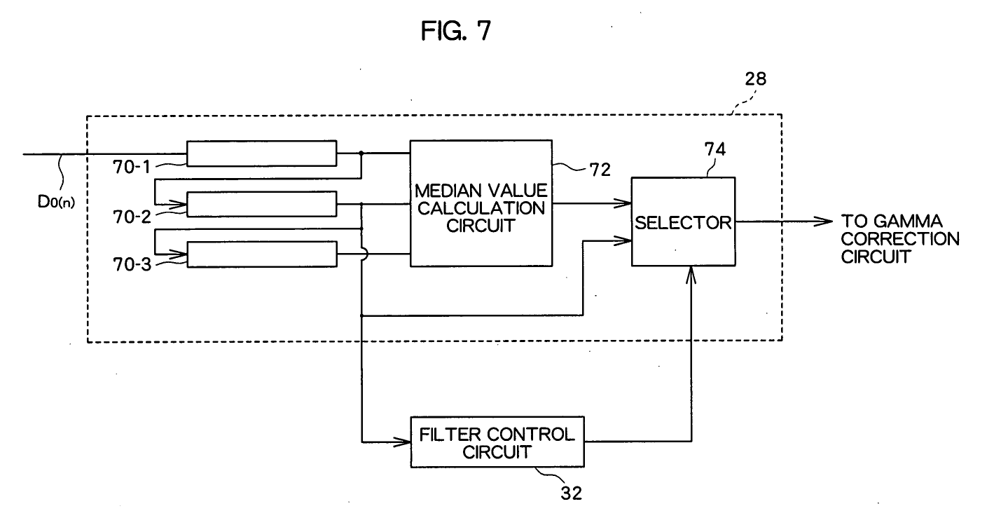

FIG. 7 is a block diagram showing schematic circuit configurations of the filter circuit 28 and the filter control circuit 32, which circuit configurations are different from those shown in FIG. 5. The filter circuit 28 includes a median filter having line memories 70-1 to 70-3 and a median value calculation circuit 72 and a selector 74 for selecting either one of an output from the median filter and an image signal which has not passed through the median filter. As the filter control circuit 32, those having a constitution similar to that shown in FIG. 5 can be used, and the selector 74 performs the switching based on an output from the filter control circuit 32.

A filter size of the median filter is 3×3 pixels, and the line memories 70-1 to 70-3 for retaining image data for three adjacent lines are used corresponding to the filter size. The line memories 70-1 to 70-3 are serially connected, and image data for one line input to the line memory 70-1 are transferred to the line memories 70-2 and 70-3 sequentially and interlockingly with inputs for the subsequent lines. The median value calculation circuit 72 acquires image data for 9 pixels constituting a pixel region of the 3×3 pixels from the line memories 70-1 to 70-3 and outputs a median value of the image data as a value of a central pixel of the pixel region to the selector 74. Original image data of the central pixel is also input to the selector 74 from the line memory 70-2.

The filter control circuit 32 acquires the image data of the central pixel, the two preceding pixels and the two following pixels from the line memory 70-2. In the case where the image data of the five pixels are equal to or higher than R, the filter control circuit 32 controls the selector 74 so that the selector 74 outputs the original image data of the central pixel to the gamma correction circuit 30. In the case where any one of the image data of the five pixels are lower than R, the filter control circuit 32 controls the selector 74 so that the selector 74 outputs the output value of the median value calculation circuit 72.

In the filter control circuit 32 shown in FIG. 5, the number of pixels for obtaining the logical product in the AND circuit 64 can be changed to 3 to be in conformity with the filter size of the median filter. Though either one of the median filter having the filter size of 3×3 pixels and the original image data on which the median filter processing has not been performed is selected in this constitution, a plurality of median filters different in filter size may be used, and either one of outputs from the median filters may be selected based on a judgment result of signal levels by the filter control circuit 32. For instance, a median filter having a filter size of 3×3 pixels and a median filter having a filter size of 5×5 pixels may be used, so that the filter control circuit 32 selects an output from the 3×3 pixel median filter when image data of five pixels including a central pixel are equal to or higher than R, while the filter control circuit 32 selects an output from the 5×5 pixel median filter which has a greater noise elimination effect when any one of the image data of the five pixels are lower than R.

Also, the filter circuit 28 may have a constitution which can be achieved by combining the constitutions of FIG. 5 (either one of the LPFs is selected) and FIG. 7 (the median filter is used). For instance, the output from the selector 44 may be connected to an input of the line memory 70-1 to combine the constitutions.

Though one threshold value R is set depending on a slope of the conversion characteristic of the gamma correction circuit 30 to divide the signal levels of the input image signals into the two signal level ranges in the above-described constitution, the number of signal level ranges may be increased. In the case of increasing the number of the signal level ranges, filters varying in noise component attenuation degree are provided depending on slopes of conversion characteristic of the ranges, so that the selector selects one of the outputs from the filters as the output to be sent to the gamma correction circuit 30.

Though the foregoing description has been made on the assumption of using a monochrome CCD image sensor, the image signal processing apparatus of this invention is applicable to image signals output from a CCD image sensor having a color filter of plural colors. For instance, in the case of processing image signals input from an image sensor having a mosaic color filter, the signal level judgment in the filter control circuit 32, the filtering in the LPFs 40 and 42, and the median filter processing in the median value calculation circuit 72 can be performed on a luminance signal or pixels one of the same color that are arranged periodically in the vertical and horizontal directions.

1. An image signal processing apparatus comprising a gradation correction circuit for performing gradation correction processing by converting a signal level of an image signal based on a nonlinear characteristic, comprising:
a filter circuit which is disposed serially with the gradation correction circuit and attenuates a noise component contained in the image signal, a noise component attenuation characteristic of the filter circuit being variable; and
a filter control circuit for judging a signal level of the image signal corresponding to a pixel and changes the noise component attenuation characteristic of the filter circuit for the pixel in accordance with the signal level.

2. The image signal processing apparatus according to claim 1, wherein
a plurality of signal level ranges are set based on degrees of expansions of gradations performed by the gradation correction circuit; and
the filter control circuit changes the noise component attenuation characteristic in such a manner that a high noise component attenuation degree is achieved when the expansion degree of the signal level range to which the detected signal level belongs is high.

3. The image signal processing apparatus according to claim 1, wherein
the filter circuit is a low pass filter comprising a digital filter, and
the filter control circuit changes a cutoff frequency of the low pass filter by changing tap coefficients of the digital filter.

4. The image signal processing apparatus according to claim 1, wherein
the filter circuit has a median filter processing function, and
the filter control circuit switches between performance and non-performance of the median filter processing function or between median filter sizes.

5. The image signal processing apparatus according to claim 1, wherein
the filter circuit includes a vertical low pass filter for attenuating a frequency component corresponding to ½ of a vertical sampling frequency of an image and a horizontal low pass filter for attenuating a frequency component corresponding to ½ of a horizontal sampling frequency of the image, and
the vertical low pass filter and the horizontal low pass filter are serially connected with each other and an attenuation characteristic of each of the vertical low pass filter and the horizontal low pass filter is variable.

6. The image signal processing apparatus according to claim 5, wherein
cutoff frequencies of the vertical low pass filter and the horizontal low pass filter are variable, and
the filter control circuit changes each of the cutoff frequencies of the vertical low pass filter and the horizontal low pass filter in accordance with the signal level.
